(19) United States
(12) Patent Application Publication
(10) Pub. No.: US 2013/0036982 A1
(43) Pub. Date: Feb. 14, 2013

(54) Flip n Go

(71) Applicants: Melinda Marie Cameron, Mill Creek, WA (US); Scott David Bartholdson, Mill Creek, WA (US)

(72) Inventors: Melinda Marie Cameron, Mill Creek, WA (US); Scott David Bartholdson, Mill Creek, WA (US)

(73) Assignees: Scott David Bartholdson, Mill Creek, WA (US); Melinda Marie Cameron, Mill Creek, WA (US)

(21) Appl. No.: 13/555,193

(22) Filed: Jul. 23, 2012

Related U.S. Application Data
(60) Provisional application No. 61/521,127, filed on Aug. 8, 2011.

(51) Int. Cl. A01K 29/00

(52) U.S. Cl. 119/166

(57) ABSTRACT

The Flip ‘n’ Go is a self-contained litter box comprising an attachable filtering mechanism for use in collecting waste matter from within the box thereby providing consumers with a simple and sanitary means of disposing pet waste.

### CROSS-REFERENCE TO RELATED APPLICATIONS

This application claims priority to U.S. Provisional Application No. 61/521,127, entitled “Flip n Go” and filed on Aug. 8, 2011, the disclosure of which is hereby incorporated in its entirety by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates generally to the field of litter boxes and more specifically relates to litter boxes comprising an attachable filtering mechanism for use in collecting waste matter from within the box thereby providing consumers with a simple and sanitary means of disposing pet waste.

2. Description of the Related Art

A litter box, sometimes called a sandbox, sand box, litter tray, litter pan, catbox, or cat box, is an indoor feces and urine disposal box for cats (as well as rabbits, snakes and other pets that naturally or through training will make use of such a repository) that are permitted free roam of a home but who cannot or do not always go outside to relieve themselves. Many owners of these animals prefer not to let them roam outside for fear that they might succumb to the elements or get hit by a car, so a cat litter box makes it possible to shelter pets from these risks.

In the wild, cats naturally excrete in soft or sandy soil for easy burial. To simulate this instinctive desire, a litter box's bottom is filled typically with an inch or more of cat litter. Litter box filler is a loose, granular material that absorbs moisture and odors such as ammonia. Some litter brands contain baking soda, to absorb such odors. The litter material also satisfies a cat's instinctive desire to use an easily-dug material. The most common material is clay, although recycled paper “pellets” and silicon based “crystal” variants are also used. Unfortunately, if litter used in litter boxes is not removed promptly, strong odors may be produced in the surrounding area around the litter box along with an excessive amount of wasted litter when the soiled litter box is emptied and/or disposed of.

Various attempts have been made to solve problems found in the litter box art. Among these are found in: U.S. Pat. No. 5,207,772 to Lauretta; U.S. Pat. No. 5,564,366 to Hancok; and U.S. Pat. No. 5,799,610 to Poulos. This prior art is representative of litter boxes.

None of the above inventions and patents, taken either singly or in combination, is seen to describe the invention as claimed. Thus, a need exists for a reliable litter box comprising an attachable filtering mechanism for use in collecting waste matter from within the box thereby providing consumers with a simple and sanitary means of disposing pet waste and to avoid the above-mentioned problems.

### BRIEF SUMMARY OF THE INVENTION

In view of the foregoing disadvantages inherent in the known litter box device art, the present invention provides a novel flip ‘n’ go. The general purpose of the present invention, which will be described subsequently in greater detail, is to provide a self-contained litter box comprising an attachable filtering mechanism for use in collecting waste matter from within the box thereby providing consumers with a simple and sanitary means of disposing pet waste. The features of the invention which are believed to be novel are particularly pointed out and distinctly claimed in the concluding portion of the specification. These and other features, aspects, and advantages of the present invention will become better understood with reference to the following drawings and

### DETAILED DESCRIPTION

### Brief Description of the Drawings

The figures which accompany the written portion of this specification illustrate embodiments and method(s) of use for the present invention, Flip ‘n’ Go, constructed and operative according to the teachings of the present invention.

FIG. 1 shows a perspective view illustrating a Flip ‘n’ Go in an open position according to an embodiment of the present invention.

FIG. 2 is a perspective view illustrating the Flip ‘n’ Go in a closed position according to an embodiment of the present invention.

FIG. 3 is a perspective view illustrating a filter basket of the Flip ‘n’ Go according to an embodiment of the present invention.

FIG. 4 is a perspective view illustrating the filter basket in a folded position of the Flip ‘n’ Go according to an embodiment of the present invention.

The various embodiments of the present invention will hereinafter be described in conjunction with the appended drawings.

### DETAILED DESCRIPTION OF THE INVENTION

As discussed above, embodiments of the present invention relate to a litter box device and more particularly to a Flip ‘n’ Go having a self-contained litter box comprising an attachable filtering mechanism for use in collecting waste matter from within the box thereby providing consumers with a simple and sanitary means of disposing pet waste.

Millions of Americans love cats. Extremely popular as household pets, there are over 75 million of these animals owned in the United States. According to statistics compiled by the Americans Pet Products Manufactures Association (APPMA), cats are such a favored pet, that fifty percent of those who own a cat, own more than one. With a life expectancy of over fifteen years, most people consider their cats to be more than just a pet, but rather a member of the family. Arguably intelligent, cats are self-grooming and most importantly, easily trained in use of a litter box.

Litter boxes are a must-have item for those who own an indoor cat. Providing the animal with a sanitary and recognizable space in which to eliminate bodily waste, litter boxes are an important tool for any home that boasts one of these delightful creatures as a pet. Most litter boxes are made of plastic, have a rectangular shape and are filled with specially treated sand or clay litter. Although most cats are naturally motivated to use these receptacles, litter boxes have one major drawback . . . cleaning.

Most cat owners change the litter box on a weekly basis. However, in order to maintain the litter box throughout the week, conscientious pet owners scoop solid waste from the box, thus extending the life of the litter. Using a small, handheld shovel-like scoop caring cat owners literally scoop solid waste from the box, tossing this waste in a trash receptacle for neat disposal. As may be imagined, scooping solid waste from a litter box may be a less than pleasant experience. Frustrated by this unpleasant task, many pet owners will simply dump the entire litter box rather than having to deal with this noxious matter, wasting expensive and perfectly good litter. Considering that most cats eliminate waste several times a day, scooping solid or clump waste from a litter box may also be a time consuming endeavor and is a task most pet owners may rather avoid.

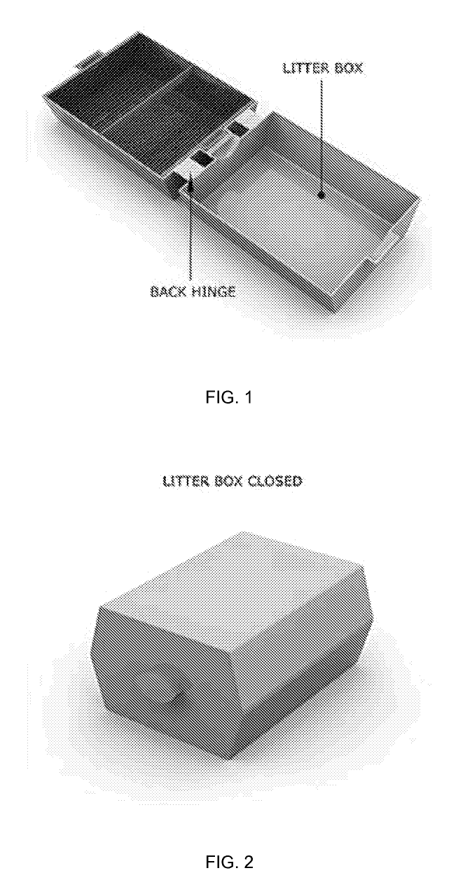

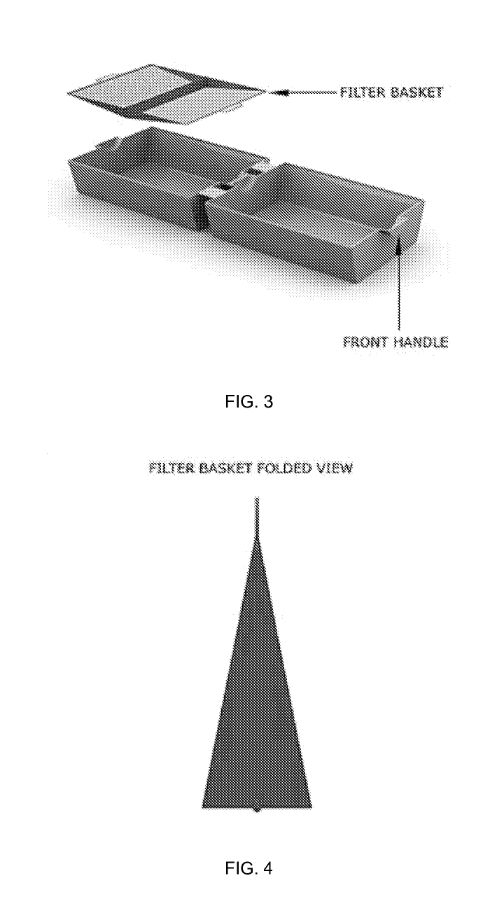

Referring now to the drawings FIGS. 1-4, the Flip ‘n’ Go comprising a novel product offering consumers a practical solution to the aforementioned challenges. As the name implies, the Flip ‘n’ Go comprises a specially designed litter box comprising an easily operated filtering mechanism with which to neatly remove solid waste from the box. Manufactured of heavy duty plastic material, the Flip ‘n’ Go may be comprised of three main components; the litter box, filter and lid. Similar in size and shape to a traditional litter box, the Flip ‘n’ Go litter box may be a rectangular shaped receptacle boasting a flat base and raised side walls, with the unit having adequate length and depth to accommodate a full grown cat.

Positioned on either end of the unit and located on the lip of the box may be grooved niches designed to accommodate the second component of the Flip ‘n’ Go; the filter mechanism. The filter itself may be a basket-like liner featuring solid perimeter walls, with the basket itself tapering inwards on either side to form a “V” shape. Designed to be secured over the litter box in the inverted position, this filter may feature a gridded surface, with the grid sized appropriately to allow litter to pass through, while capturing and containing waste matter.

To facilitate easy collection and disposal of waste, either end of the filter basket may boast an integrated, two-piece handle that connects to the unit lid via a simple interlocking hinge mechanism. The lid itself may feature the same basic dimensions of the litter box and, as mentioned may be connected to the box by way of the previously mentioned interlocking hinge/handle positioned on either end of the unit. The Flip ‘n’ Go may be offered in a variety of colors, as well as basic neutral hues. Further, the Flip ‘n’

Go is preferably manufactured of heavy duty, clear plastic material, however other heavy duty materials may be used.

Use of the Flip ‘n’ Go may be very simple and straight forward. First, the user may place the Flip ‘n’ Go in the desired area of the home, such as in a laundry room, coat room or other area deemed appropriate. The user may then fill the Flip ‘n’ Go with their favorite brand of cat litter. After solid and clumped waste had accumulated in the box, the pet owner may filter out this waste matter via the included filter basket.

Securing the inverted basket over the top of the litter box and positioning the device so that either end of the filter was anchored via the corresponding grooved niche, the user may close the unit lid over the basket, snapping the components together via the interlocking hinged handles. With the filter and lid applied, the user may pick up the Flip ‘n’ Go via the unit handles and flip the entire litter box over. The user may then gently tap on the lid, thus causing the actual litter to pass through the filter, while the waste matter is collected within the filter basket. The user may then open the Flip ‘n’ Go, removing the filter and disposing the collected waste. The Flip ‘n’ Go may be ready to use after shifting it back and forth from side to side.

There are many significant benefits and advantages afforded by the Flip ‘n’ Go. Foremost, the Flip ‘n’ Go may offer consumers a practical modification to the design of a litter box which may facilitate the simple and sanitary disposable of solid waste. A specially designed litter box boasting an easily operated filter basket inside of which all solid or clumped matter deposited in the box may be neatly and easily collected, the Flip ‘n’ Go may provide a simple means of maintaining a sanitary environment for one's beloved pet. With the Flip ‘n’ Go, caring cat owners may never again have to scoop waste manually, but rather may remove all waste matter simply by applying the filter basket and lid and flipping the device over.

As such, the Flip ‘n’ Go may enable consumers to care for their pet's most basic needs with convenience and ease. Consumers may appreciate the clever design of the filter's integrated handles may enable them to lift, carry and discard the filled basket and its contents, without ever touching the refuse itself. Preventing the spread of germs and bacteria from the box to the user, the Flip ‘n’ Go may prove an invaluable commodity to any cat owner. Offering a hygienic solution to the problems associated with pet waste, use of the Flip ‘n’ Go may ensure a clean and healthy environment for the animal, as well as the human owner and other household residents. Sparing the user the costly expense of discarding perfectly good litter, simply because they are unwilling to clean the cat's box of solid waste, use of the Flip ‘n’ Go may extend the life of the litter, saving the pet owner money. In addition to household applications, this product may be particularly beneficial for use by establishments that house and care for many animals such as veterinary clinics, pet boarding facilities, pet groomers and animal shelters.

The Flip ‘n’ Go is a practical product invention that may provide cat lovers an easy means of providing their pet with a fresh, clean litter box. Easy to use and durably constructed, this unique product may prove a valuable investment for any cat lover. Affordably priced, the Flip ‘n’ Go may be well received by millions of cat owners and pet establishments across the country, a sizable market potential.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. The Flip ‘n’ Go is a self-filtering litter box device which is designed to be a fast and efficient way of separating pet waste from litter by flipping.

2. A self-filtering litter box device as in claim 1, wherein two litter pans are interlocked by separable hinges at one end, so as to allow the Flip ‘n’ Go to open and close, and be separated for easy cleaning and storage.

3. A self-filtering litter box device as in claim 2, wherein a hinged Filter Basket is placed between the two litter pans whereby the flipping process allows waste to be separated from the litter by gravity.

4. A self-filtering litter box device as in claim 3, wherein the Filter Basket allows litter to filter through, while catching pet waste during the flipping process.

5. A self-filtering litter box device as in claim 4, wherein the Filter Basket can be folded to capture and remove waste.
